(19) United States
(12) Patent Application Publication
(10) Pub. No.: US 2004/0125714 A1
(43) Pub. Date: Jul. 1, 2004

(54) Method and system for background formatting optical recording medium

(75) Inventors: Yuan-Ting Wu, Hsin-Chu City (TW); Tse-Hong Wu, Hsin-Chu City (TW)

Correspondence Address: TROXELL LAW OFFICE PLLC, SUITE 1404, 5205 LEESBURG PIKE, FALLS CHURCH, VA, 22041, US

(73) Assignee: MediaTek Inc.

(21) Appl. No.: 10/623,596

(22) Filed: Jul. 22, 2003

(30) Foreign Application Priority Data
Oct. 15, 2002 (TW) 091123668

(51) Int. Cl. G11B 7/0045

(52) U.S. Cl. 369/47.14; 369/59.25

(57) ABSTRACT

This invention provides a method to background format an optical recording medium. The optical recording medium comprises defect management areas (DMAs). Each DMA comprises a data area (DA) and a spare area (SA). Each DA and each SA comprise packets to record digital data. Each packet comprises blocks. Each block has a corresponding address for distinguishing the blocks. The background formatting method is to establish a format recording table with recording units to record whether the packets in the DMAs have recorded digital data. Store the format recording table in a memory. When format a certain packet in the optical recording medium, inspect the corresponding recording unit in the format recording table. If the corresponding unit indicates that there is no digital data in the current packet, start formatting. Otherwise, skip the current packet and format the next packet.

### BACKGROUND OF THE INVENTION

1. Field of the Invention

This present invention relates to a format method, and particularly, to a method for an optical recording device to background format an optical recording medium.

2. Description of the Prior Art

Conventionally, a background formatting method means that when an optical recording device receives a command from a host computer to format an optical recording medium, the optical recording device first performs a necessary preliminary formatting procedure for the optical recording medium and then sends a reply message to the host computer to tell that the optical recording medium has been formatted. Generally, only a main table area, a pre-gap and a general application area on the optical recording medium are formatted in the necessary preliminary formatting procedure. Therefore, the user can read or write the data on the optical recording medium without waiting for the entire optical recording medium to be formatted. The efficiency of the optical recording device is improved since the optical recording medium can quickly reach its user accessible status.

However, if a user wants to read an unformatted and unwritten area on the optical recording medium, the optical recording device will spend a long time still trying to read data. Then a predetermined message of finishing formatting is sent out in order to continue later processes. In such case, time is wasted since no data exists, and the optical recording device is considered inefficient.

Besides, when the user asks to write data in an unformatted area, the data will be destroyed if that area is not skipped but directly formatted later in the background formatting procedure.

There are methods to solve the above-mentioned problems. The address of the location where the user asks to write data can be recorded in a recording table in the memory of the optical recording device. However, each address needs at least 3 to 4 bytes and the recording table usually needs 2 to 8 MB. Since the memory capacity is limited, the storage function of the memory will be influenced. Furthermore, every time when judging whether the next packet can be formatted or not, the optical recording device needs to check the table over and over again, substantially reducing the reading/writing efficiency of the optical recording device.

### SUMMARY OF THE INVENTION

Accordingly, an objective of the invention is to provide a method and a system of background formatting for an optical recording medium, to solve the above-mentioned problems.

In a preferred embodiment, the present invention provides a method for an optical recording device to background format an optical recording medium. The optical recording medium comprises a plurality of defect management areas (DMAs) arranged sequentially. Each of the DMAs comprises a data area (DA) and a spare area (SA). Each of the DAs and each of the SAs comprise a plurality of packets to record digital data. Each of the packets comprises a plurality of blocks. Each block has a corresponding address for identifying the information of the blocks. In the background formatting method, establish a format recording table to record whether the packets in the DMAs have been recorded with digital data, and store the format recording table in a memory in the optical recording device. Then, before formatting a certain packet in the optical recording medium, the corresponding recording unit in the format recording table is inspected. If the corresponding recording unit indicates that there is no digital data in the current packet, start formatting. Otherwise skip the current packet and format the next packet.

It is the advantage of the present invention that the present invention takes smaller memory and the reading/writing efficiency of the optical recording device can be improved.

The advantage and spirit of the invention may be understood by the following recitations together with the appended drawings.

### BRIEF DESCRIPTION OF THE APPENDED DRAWINGS

FIG. 1 is a block diagram of a background formatting system with an optical recording device and a host computer according to the present invention.

FIG. 2 is a schematic diagram of an optical recording medium corresponding to the optical recording device shown in FIG. 1.

FIG. 3 is a schematic diagram of the format recording table shown in FIG. 1.

FIG. 4 is a flow chart of the background formatting method performed by the background formatting system shown in FIG. 1.

### DETAILED DESCRIPTION OF THE INVENTION

The present invention provides a system and a method for an optical recording device to background format an optical recording medium. The optical recording medium can be a CD (compact disk) of CD-RW (Compact Disk ReWritable) or DVD+RW (Digital Versatile Disk plus ReWritable). The optical recording device can be a corresponding CD or DVD drive.

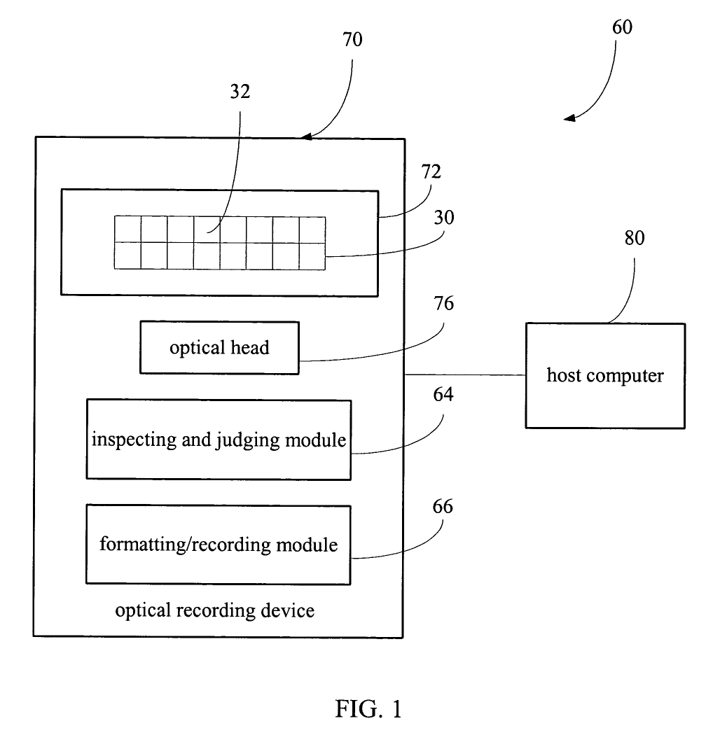

Referring to FIG. 1, FIG. 1 is a block diagram of a background formatting system 60 with an optical recording device 70 and a host computer 80 according to the present invention. The optical recording device 70 comprises a memory 72. The memory 72 is a DRAM, comprising a plurality of memory units numbered sequentially (not shown in FIG. 1). The optical recording device 70 comprises an optical head 76 to read or write data on an optical recording medium. The optical recording device 70 receives a computer command from the host computer 80, and operates according to the content of the computer command. The computer commend can be a formatting command, a data writing command or a data reading command.

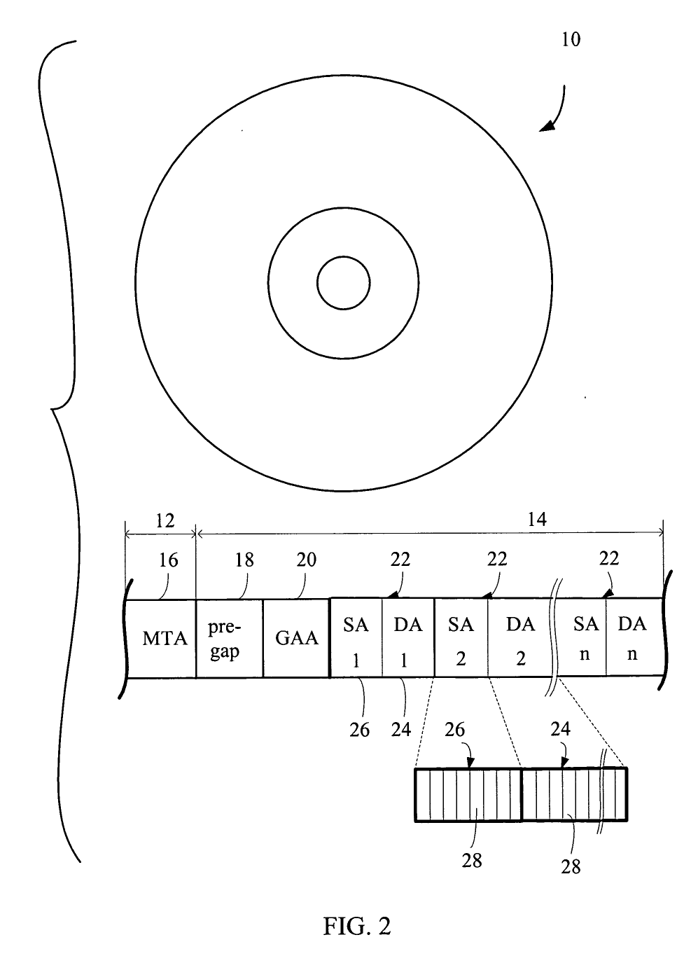

Referring to FIG. 2, FIG. 2 is a schematic diagram of an optical recording medium 10 corresponding to the optical recording device 70 shown in FIG. 1. The optical recording medium 10 is corresponding to the optical recording device 70. The optical head 76 can read or write data on the optical recording medium 10. The optical recording medium 10 comprises a lead-in area (LA) 12 and a program area (PA) 14. The LA 12 at least comprises a main table area (MTA) 16. The PA 14 comprises a pre-gap 18, a general application area (GAA) 20 and a plurality of defect management areas (DMAs) 22 arranged sequentially. Each DMA 22 comprises a data area (DA) 24 and a spare area (SA) 26. Each DA 24 has 136 packets 28 for recording digital data. The SA 26 comprises 8 packets for recording digital data. The pocket is used as a unit for recording digital data. Each of the packets 28 comprises a plurality of blocks. Each block has a corresponding address for distinguishing the sequence information in the corresponding packet 28. A complete DMA 22 has total 144 packets. The optical recording medium 10 has at most 64 DMAs 22, so the optical recording medium 10 has at most 9216 packets 28.

As shown in FIG. 1, the background formatting system 60 comprises a format recording table 30, an inspecting and judging module 64 and a formatting/recording module 66. The format recording table 30 is stored in the memory 72. The format recording table 30 comprises a plurality of recording units 32 corresponding to some predetermined memory units in the memory 72. The recording units 32 are used to record whether the packets 28 in the DMAs 22 have been recorded with digital data. The inspecting and judging module 64 is used for inspecting the corresponding recording unit 32 in the format recording table 30, when formatting a certain packet in the optical recording medium 10 by a predetermined formatting process. The formatting/recording module 66 can format the packet with the predetermined formatting process.

The inspecting and judging module 64 is used to inspect the corresponding recording unit in the format recording table 30 when formatting a certain packet 28 of the optical recording medium 10 with the predetermined formatting process. If the corresponding recording unit indicates that there is no digital data in the current packet 28, the formatting/recording module 66 starts formatting by the predetermined formatting process, otherwise skips the current packet and formats the next packet.

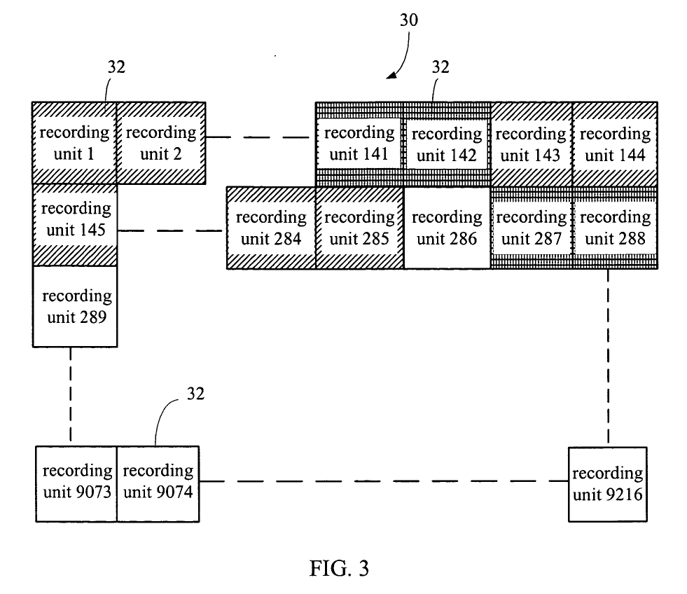

Referring to FIG. 3, FIG. 3 is a schematic diagram of the format recording table 30 shown in FIG. 1. In the embodiment shown in FIG. 3, the format recording table 30 has total 9216 recording units 32. In order to better explain the embodiment, label each of the recording units (shown in FIG. 3) one by one from 1 to 9216, and label each of the SAs 26 and DAs 24 (shown in FIG. 2) from 1 to n, respectively. Each recording unit 32 one by one corresponds to the packet 28. The recording units 1 to 8 corresponds to 8 packets 28 in the SA 1 of DMA; the recording units 9 to 144 corresponds to 136 packets 28 in the DA 1; the recording units 145 to 152 corresponds to 8 packets 28 in the SA 2; the recording units 153 to 288 corresponds to 136 packets 28 in the DA 2, and so on. To better explain the embodiment, these packets 28 corresponding to the recording units are also numbered sequentially from 1 to 9216.

Each recording unit 32 stores a writing flag to show whether its corresponding packet has recorded with digital data. In an embodiment, the memory capacity of each recording unit 32 is two bits. When the writing flag is 00, the corresponding packet is not formatted and has no digital data, referring to the recording units with blank pattern shown in FIG. 3. When the writing flag is 01, the corresponding packet has already recorded with digital data, referring to the recording units with checker pattern shown in FIG. 3. When the writing flag is 10, the corresponding packet has been formatted, referring to the recording units oblique lines shown in FIG. 3. In the embodiment shown in FIG. 3, the writing flag of the recording unit 9074 is 00; the writing flag of the recording unit 141 is 01; and the writing flag of the recording unit 1 is 10.

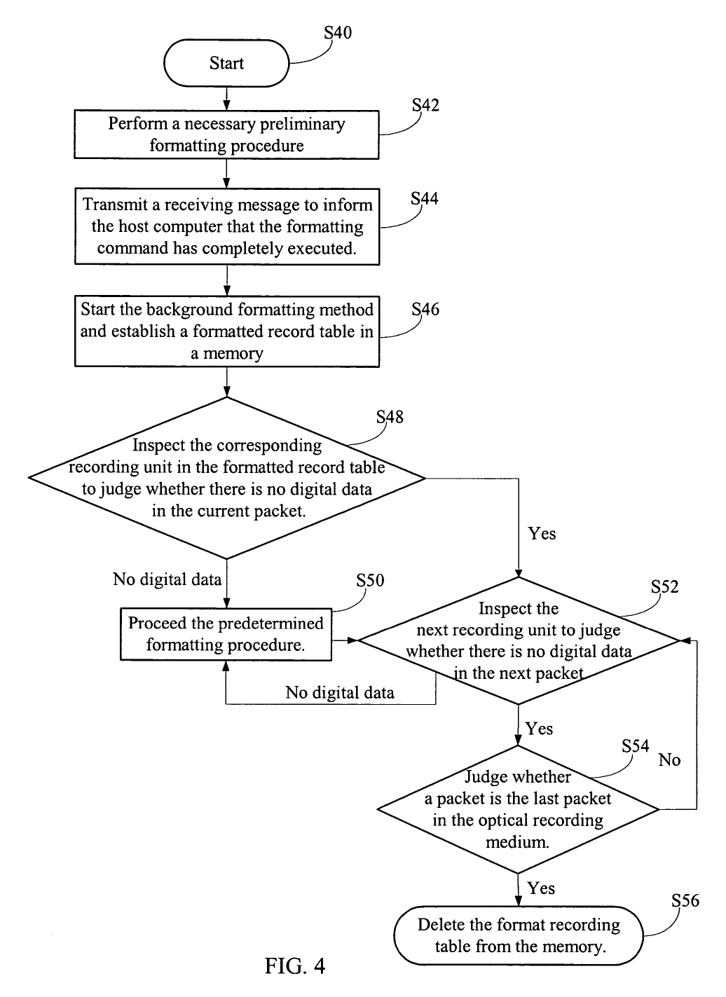

Referring to FIG. 4, FIG. 4 is a flow chart of the background formatting method performed by the background formatting system 60 shown in FIG. 1. When the host computer 80 sends a formatting command to the optical recording device 70, start the background formatting method of the present invention. The background formatting method of the present invention comprises the following steps:

Step S40: Start.

Step S42: The optical recording device 70 performs a necessary preliminary formatting procedure to the optical recording medium 10. Only the MTA 16, the pre-gap 18 and the GAA 20 are formatted in the necessary preliminary formatting procedure.

Step S44: The optical recording device 70 transmits a receiving message to inform the host computer 80 that the formatting command has completely executed.

Step S46: After the optical recording device 70 transmits the receiving message to the host computer 80, establish a format recording table 30 and store it in the memory 72 of the optical recording device 70.

Step S48: Before performing a predetermined formatting process for a certain packet of the optical recording medium 10, inspect the corresponding recording unit 32 in the format recording table 30 to judge whether there is no digital data in the current packet. If the corresponding recording unit 32 indicates that there is no data in the current packet, go to step S50. If the corresponding recording unit 32 indicates that there are data in the current packet, go to step S52.

Step S50: Proceed the predetermined formatting process.

Step S52: If the corresponding recording unit 32 indicates that there are digital data in the current packet, skip the current packet and go to the next packet. Inspect the next recording unit to judge whether there is no digital data in the next packet. If the next recording unit indicates that there is no digital data in the next packet, go back to step S50 and start formatting. If the next recording unit indicates that there are digital data in the next packet, skip formatting and go to step S54.

Step S54: For the next packet that has been judged that it is with digital data, judge whether it is the last packet in the optical recording medium 10. If not, return to step S52. If yes, go to step S56.

Step 56: The next packet is the last packet in the optical recording medium 10 and the background formatting procedure is finished. Delete the format recording table 30 from the memory 72 to release the memory capacity.

In the step S50 in the background formatting method, first judge the packet 1 to see whether there is no digital data in the packet 1. If the packet 1 has no digital data, format it. Otherwise skip formatting the packet 1 and go on following necessary steps. In this way, gradually process the next packet 2, 3, 4, . . . etc with necessary steps. The predetermined formatting process is that the formatting/recording module 66 writes a formatted information in the current packet 28 for identifying the current packet 28 as a formatted packet. Generally, the formatted information is 0×AA. The optical head 76 writes 0×AA into the packet 28 to perform formatting for the packet 28.

Because the necessary preliminary formatting procedure only formats the MTA 16, the pre-gap 18 and the GAA 20, and then transmits a receiving message to notify the host computer 80 that the formatting command has completely executed, the optical recording device 70 still can receive the data writing command and the data reading command sent by the host computer 80 to read or write the optical recording medium 10 before the whole optical recording medium 10 is formatted.

In the embodiment shown in FIG. 3, the formatting procedure has processed to the packet corresponding to the recoding unit 285. At this moment, if the host computer 80 sends the data writing command to the optical recording device 70, the optical recording device 70 will record the digital data in the corresponding packet of the optical recording medium 10 according to the address in the data writing command. In this embodiment, although the packets corresponding to the recoding units 287 and 288 are not actually formatted, the optical recording device 70 still can record the digital data in the corresponding packet according to the command sent by the host computer 80, and then records the recoding units 287 and 288 in the format recording table 30 with the information that this two packets already have digital data. Later on when the optical recording device 70 intends to format the packets corresponding to the recording units 287 and 288 with the predetermined formatting process, the optical recording device 70 first inspects the recording units 287 and 288. Because the recording units 287 and 288 are 01, the optical recording device 70 will skip the packets corresponding to the recoding units 287 and 288, and go to the next packet for formatting. This can avoid destroying the digital data that have been recorded.

In another embodiment according to the present invention, if the host computer 80 transmits the data reading command to the optical recording device 70, the optical recording device 70 inspects the recording unit according to the address in the data reading command. In this embodiment, it is the recording unit 289 in FIG. 3. By inspecting the recording unit 289, the packet corresponding to the recoding unit 289 can be judged whether it is unformatted and unrecorded with any digital data.

In the case that the packet corresponding to the recoding unit 289 is unformatted and unrecorded with any digital data, the optical head of the conventional optical recording device will directly go to that packet and try to read data again and again. Reading is eventually failed and the formatted message is transmitted to the host computer. A lot of time has been wasted. According to the embodiment of the present invention, after judgment, if the packet is unformatted and unrecorded with any digital data, the optical recording device 70 does not drive the optical head 76 to read data but directly transmits the formatted message to the host computer 80. Since the optical head 76 does not need to try to read data, the efficiency of the optical recording device 70 can be improved.

In another embodiment, the memory capacity of every recording unit can be reduced to 1 bit. For example, when the writing flag is 0, the packet does not record with digital data. When the writing flag is 1, the packet has already recorded with digital data. As a result, the format recording table 30 takes even smaller memory.

The present invention provides a system and a method to background format an optical recording medium. When background formatting, first establish a format recording table and store the format recording table in a memory of the optical recording device. When formatting a certain packet of the optical recording medium, inspect the corresponding recording unit in the format recording table. If the corresponding recording unit indicates that there is no digital data in the current packet, start formatting. Otherwise skip the current packet and format the next packet. In contrast to the prior art that occupies a large memory and reduces the efficiency of the optical recording device, the present invention takes smaller memory and the reading/writing efficiency of the optical recording device can be improved.

With the examples and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for an optical recording device to background format an optical recording medium, the optical recording medium comprising a plurality of defect management areas (DMAs) arranged sequentially, each of the DMAs comprising a data area (DA) and a spare area (SA), each of the DAs and each of the SAs comprising a plurality of packets to record digital data, each of the packets comprising a plurality of blocks, each block having a corresponding address for distinguishing, the background formatting method comprising the following steps:
(A) establishing a format recording table and storing the format recording table in a memory in the optical recording device, the format recording table comprising a plurality of recording units to record whether the packets in the DMAs are recorded with digital data;
(B) when formatting a certain packet in the optical recording medium by a predetermined formatting process, inspecting the corresponding recording unit in the format recording table; if the corresponding recording unit indicates that there is no digital data in the current packet, starting formatting, otherwise skipping the current packet and formatting the next packet; and
(C) repeating step (B) for all the packets in the optical recording medium.

2. The background formatting method of claim 1, wherein the optical recording device receives a computer command from a host computer, and the optical recording device operates according to the content of the computer command.

3. The background formatting method of claim 2, wherein the computer command is chosen from one of the following commands: a formatting command, a data writing command and a data reading command.

4. The background formatting method of claim 3, wherein the optical recording device comprises an optical pickup head to read/record data in the optical recording medium, and the predetermined formatting process is performed by the optical pickup head writing a formatted information in the packet designated to format in the optical recording medium for identifying.

5. The background formatting method of claim 4, wherein when the host computer transmits a formatting command to the optical recording device, the optical recording device performs only a necessary preliminary formatting procedure and then transmits a receiving message to inform the host computer that the formatting command has completely executed.

6. The background formatting method of claim 5, wherein the optical recording medium comprises a main table area (MTA), a pre-gap and a general application area (GAA), the necessary preliminary formatting procedure formatting only the MTA, the pre-gap and the GAA to the optical recording medium.

7. The background formatting method of claim 5, wherein after transmitting the receiving message to the host computer, the optical recording device proceeds with the step (A), step (B) and step (C) in the background formatting method to finish formatting the optical recording medium.

8. The background formatting method of claim 7, wherein every recording unit of the format recording table corresponds one by one to a packet in a DMA.

9. The background formatting method of claim 8, wherein before formatting the optical recording medium is completed, if the host computer transmits the data writing command to the optical recording device, the optical recording device will record the digital data in the corresponding packet, according to the address in the data writing command, in the optical recording medium and record an information that the packet already has digital data on the corresponding recording unit in the format recording table.

10. The background formatting method of claim 7, wherein before formatting the optical recording medium is finished, if the host computer transmits the data reading command to the optical recording device, the optical recording device inspects the corresponding recording unit, according to the address in the data reading command, to judge whether the packet in the optical recording medium has not been formatted and not recorded any digital data, then transmits the formatted message to the host computer after judged that the packet has not been formatted and not recorded.

11. The background formatting method of claim 10, wherein when the optical recording device receives the data reading command, if the packet in the optical recording medium is confirmed as not formatted and not recorded with any digital data, the optical recording device will not drive the optical recording device to read data and will directly transmit the formatted message to the host computer.

12. The background formatting method of claim 1, wherein the memory comprises a plurality of memory units numbered sequentially, the recording units in the format recording table correspond to some memory units stored in the memory.

13. The background formatting method of claim 12, wherein each of the recording units stores a writing flag to show whether the corresponding packet has recorded digital data.

14. The background formatting method of claim 13, wherein the memory capacity of each recording unit is one bit; the writing flag with 0 means the corresponding block records no digital data, while the writing flag with 1 means the corresponding block records digital data.

15. The background formatting method of claim 13, wherein the memory capacity of each recording unit is two bits; the writing flag with 00 means the corresponding block is not formatted and not recorded digital data, the writing flag with 01 means the corresponding block records digital data, while the writing flag with 10 means the corresponding block is formatted.

16. The background formatting method of claim 1, wherein after the optical recording device has background formatted the whole optical recording medium, the optical recording device deletes the format recording table from the memory to release the memory capacity.

17. The background formatting method of claim 1, wherein the memory is a DRAM.

18. The background formatting method of claim 1, wherein the optical recording medium is a CD-RW (Compact Disk ReWritable) or a DVD+RW (Digital Versatile Disk plus ReWritable).

19. A system for an optical recording device to background format an optical recording medium, the optical recording medium comprising a plurality of defect management areas (DMAs) arranged sequentially, each of the DMA comprising a data area (DA) and a spare area (SA), each of the DAs and each of the SAs comprising a plurality of packets to record digital data, each of the packets comprising a plurality of blocks, each block having a corresponding address for distinguishing, the background formatting system comprising the following elements:
a format recording table, which is stored in a memory in the optical recording device, comprising a plurality of recording units to record information about whether the packets in the DMAs are recorded digital data;
an inspecting and judging module, used for inspecting the corresponding recording unit in the format recording table, when formatting a certain packet by a predetermined formatting process in the optical recording medium;
a formatting/recording module, if the corresponding recording unit indicates that there is no digital data in the current packet, starting formatting by the predetermined formatting process, otherwise skipping the current packet and formatting the next packet.

20. The background formatting system of claim 19, wherein the optical recording device receives a computer command from a host computer, and operates according to the content of the computer command.

21. The background formatting system of claim 20, wherein the content of the computer command is chosen from one of the following commands: a formatting command, a data writing command and a data reading command.

22. The background formatting system of claim 19, wherein the predetermined formatting process is that the formatting/recording module writes a formatted information in the packet designated to format in the optical recording medium for identifying.

23. The background formatting system of claim 21, wherein when the host computer transmits a formatting command to the optical recording device, the optical recording device performs only a necessary preliminary formatting procedure and then transmits a receiving message to inform the host computer that the formatting command has completely executed.

24. The background formatting system of claim 23, wherein the optical recording medium comprises a main table area (MTA), a pre-gap and a general application area (GAA), the necessary preliminary formatting procedure formatting only the MTA, the pre-gap and the GAA to the optical recording medium.

25. The background formatting system of claim 23, wherein after the optical recording device transmits the receiving message to the host computer, the formatting/recording module and the inspecting and judging module proceed with the background formatting process to finish formatting the optical recording medium.

26. The background formatting system of claim 19, wherein every recording unit of the format recording table corresponds one by one to a packet in a DMA.

27. The background formatting system of claim 21, wherein before finishing formatting the optical recording medium, if the host computer transmits the data writing command to the optical recording device, the formatting/recording module will record the digital data in the corresponding packet in the optical recording medium according to the address in the data writing command, and records an information in the corresponding recording unit of the format recording table that the packet already has digital data.

28. The background formatting system of claim 27, wherein before finishing formatting the optical recording medium, if the host computer transmits the data reading command to the optical recording device, the inspecting and judging module will inspect the recording unit, according to the address in the data reading command, to judge whether the packet in the optical recording medium is not formatted and not recorded any digital data, then transmit the formatted message to the host computer after judged that the packet has not been formatted and not recorded.

29. The background formatting system of claim 28, wherein when the optical recording device receives the data reading command, if the packet in the optical recording medium is not formatted and not record any digital data after judgment, the optical recording device does not read the packet and directly transmits the formatted message to the host computer.

30. The background formatting system of claim 19, wherein the memory comprises a plurality of memory units numbered sequentially, the recording units in the format recording table correspond to some memory units stored in the memory.

31. The background formatting system of claim 30, wherein every recording unit stores a writing flag to show whether the corresponding packet has recorded digital data.

32. The background formatting system of claim 19, wherein after the optical recording device has background formatted the whole optical recording medium, the optical recording device deletes the format recording table from the memory to release the memory capacity.

33. The background formatting system of claim 19, wherein the memory is a DRAM.

34. The background formatting system of claim 19, wherein the optical recording medium is a CD-RW or a DVD+RW.
